(19) United States
(12) Patent Application Publication
(10) Pub. No.: US 2025/0244853 A1
(43) Pub. Date: Jul. 31, 2025

(54) LARGE LANGUAGE MODEL WITH CERTAINTY VALUES

(71) Applicant: Apple Inc., Cupertino, CA (US)

(72) Inventors: Yao-Hung Tsai, Mercer Island, WA (US); Jian Zhang, Saratoga, CA (US)

(73) Assignee: Apple Inc., Cupertino, CA (US)

(21) Appl. No.: 19/033,848

(22) Filed: Jan. 22, 2025

Related U.S. Application Data
(60) Provisional application No. 63/627,155, filed on Jan. 31, 2024.

(51) Int. Cl. G06F 3/0481; G06N 20/00

(52) U.S. Cl. CPC G06F 3/0481; G06N 20/00

(57) ABSTRACT

A computer-implemented method including receiving, by a computing system, a first user input associated with a requested action, executing, by the computing system, a large language engine to generate a plurality of actions to be performed by at least a subset of the accessory devices based at least in part on the received user input, executing, by the computing system, an estimation engine to generate a certainty value associated with each action of the plurality of actions, presenting, by the computing system, a subset of actions of the plurality of actions to a user based at least in part on the certainty values of the plurality of actions, receiving, by the computing system, a second user input selecting an action of the subset of actions, and instructing, by the computing system, one or more accessory devices of the at least a subset of the accessory devices to perform the action.

### CROSS-REFERENCES TO RELATED APPLICATIONS

This application claims priority under 35 U.S.C. § 119(e) to U.S. Provisional Application Ser. No. 63/627,155, filed Jan. 31, 2024, entitled “TECHNIQUES FOR USING LARGE LANGUAGE MODELS IN DECISION PLANNING,” which is incorporated herein by reference in its entirety.

### BACKGROUND

The development and advancement of artificial intelligence engines has led to computing systems executing those engines to perform various tasks. One such task for which artificial intelligence engines has been utilized is to instruct devices to perform actions based on a user input. However, there are challenges in how those actions are generated and presented to a user.

### BRIEF SUMMARY

One aspect of the disclosure provides for a computer-implemented method including receiving, by a computing system configured to control accessory devices, a first user input associated with a requested action, executing, by the computing system, a large language engine to generate a plurality of actions to be performed by at least a subset of the accessory devices based at least in part on the received user input, executing, by the computing system, an estimation engine to generate a certainty value associated with each action of the plurality of actions, presenting, by the computing system, a subset of actions of the plurality of actions to a user based at least in part on the certainty values of the plurality of actions, receiving, by the computing system, a second user input selecting an action of the subset of actions, and instructing, by the computing system, one or more accessory devices of the at least a subset of the accessory devices to perform the action.

Implementations may include one or more of the following features. The computer-implemented method may further include presenting the subset of actions with the certainty value of each action. The computer-implemented method further may further include generating a certainty threshold value corresponding to a likelihood that a correct action is among the plurality of actions, comparing the certainty value of each action to the certainty threshold value, and identifying actions of the plurality of actions with certainty values greater than the threshold certainty value as the subset of actions for presentation. The large language engine may include the large language model such that executing the large language engine also executes the large language model. The data set may include between 15,000 and 25,000 data points. The method may further include training an estimation model to predict certainty values for future actions based at least in part on the data set. The certainty values may correspond to a likelihood that the future actions is correctly associated with future user inputs and the estimation engine may include the estimation model such that executing the estimation engine also executes the estimation model. Training the estimation model may include training the estimation model based at least in part on a point-wise dependency estimation process. The method may further include training the estimation model to predict a certainty threshold value that a correct action will be among the future actions for each user input based at least in part on the data set. Each action of the subset of actions may include a corresponding certainty value greater than the certainty threshold value. Training the estimation model may include training the estimation model based at least in part on a conformal prediction process.

One aspect of the disclosure provides for one or more non-transitory computer-readable media may include computer-executable instructions that, when executed by one or more processors, cause the one or more processors to perform operations comprising receiving, by a computing system configured to control accessory devices, a first user input associated with a requested action, executing, by the computing system, a large language engine to generate a plurality of actions to be performed by at least a subset of the accessory devices based at least in part on the received user input, executing, by the computing system, an estimation engine to generate a certainty value associated with each action of the plurality of actions, presenting, by the computing system, a subset of actions of the plurality of actions to a user based at least in part on the certainty values of the plurality of actions, receiving, by the computing system, a second user input selecting an action of the subset of actions, instructing, by the computing system, one or more accessory devices of the at least a subset of the accessory devices to perform the action.

Implementations may include one or more of the following features. Presenting the subset of actions may include presenting the subset of actions with the certainty value of each action. The operations may further include generating a certainty threshold value corresponding to a likelihood that a correct action is among the plurality of actions, comparing the certainty value of each action to the certainty threshold value, and identifying actions of the plurality of actions with certainty values greater than the threshold certainty value as the subset of actions for presentation. The operations may further include training a large language model to predict one or more actions available to be performed by the accessory devices based at least in part on a data set of historical user inputs and historical actions capable of being performed by the accessory devices for each historical input. The large language engine may include the large language model such that executing the large language engine also executes the large language model. The operations may further include training an estimation model to predict certainty values for future actions based at least in part on the data set and a point-wise dependency estimation process. The certainty values may correspond to a likelihood that the future actions is correctly associated with future user inputs and the estimation engine may include the estimation model such that executing the estimation engine also executes the estimation model. The operations may further include training the estimation model to predict a certainty threshold value that a correct action will be among the future actions for each user input based at least in part on the data set and a conformal prediction process. Each action of the subset of actions may include a corresponding certainty value greater than the certainty threshold value.

One aspect of the disclosure provides for a system including a memory that has computer-executable instructions. The system also may include a processor configured to access the memory and execute the computer-executable instructions to at least receive, by a computing system configured to control accessory devices, a first user input associated with a requested action, execute, by the computing system, a large language engine to generate a plurality of actions to be performed by at least a subset of the accessory devices based at least in part on the received user input, execute, by the computing system, an estimation engine to generate a certainty value associated with each action of the plurality of actions, present, by the computing system, a subset of actions of the plurality of actions to a user based at least in part on the certainty values of the plurality of actions, receive, by the computing system, a second user input selecting an action of the subset of actions, and instruct, by the computing system, one or more accessory devices of the at least a subset of the accessory devices to perform the action.

Implementations may include one or more of the following features. Presenting the subset of actions may include presenting the subset of actions with the certainty value of each action. The computer-executable instructions may further include generating a certainty threshold value corresponding to a likelihood that a correct action is among the plurality of actions, comparing the certainty value of each action to the certainty threshold value, and identifying actions of the plurality of actions with certainty values greater than the threshold certainty value as the subset of actions for presentation. The computer-executable instructions may further include training a large language model to predict one or more actions available to be performed by the accessory devices based at least in part on a data set of historical user inputs and historical actions capable of being performed by the accessory devices for each historical input. The large language engine may include the large language model such that executing the large language engine also executes the large language model. The computer-executable instructions may further include training an estimation model to predict certainty values for future actions based at least in part on the data set and a point-wise dependency estimation process. The certainty values may correspond to a likelihood that the future actions is correctly associated with future user inputs and the estimation engine may include the estimation model such that executing the estimation engine also executes the estimation model. The computer-executable instructions may further include training the estimation model to predict a certainty threshold value that a correct action will be among the future actions for each user input based at least in part on the data set and a conformal prediction process. Each action of the subset of actions may include a corresponding certainty value greater than the certainty threshold value.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates a block diagram showing an example device environment, according to at least one example.

FIG. 2 illustrates an example flowchart depicting a process for training a large language model and an estimation mode, according to at least one example.

FIG. 3 illustrates an example flowchart depicting a process for using a large language engine and an estimation engine, according to at least one example.

FIG. 4A illustrates an example home environment depict a user providing a user input to a computing system, according to at least one example.

FIG. 4B illustrates the home environment of FIG. 4A with the computing system presenting generated actions to the user, according to at least one example.

FIG. 4C illustrates the home environment of FIG. 4A with the user selected one of the presented actions, according to at least one example.

FIG. 4D illustrates the home environment of FIG. 4A with an accessory device performing the selected action, according to at least one example.

FIG. 5 illustrates an example flowchart depicting a process for using a large language engine and an estimation engine, according to at least one example.

FIG. 6 illustrates a simplified block diagram depicting an example architecture for implementing the techniques described herein, according to at least one example.

FIGS. 7A and 7B illustrate methods of application processes, in accordance with some embodiments.

FIG. 7C illustrates a device for implementing an API, in accordance with some embodiments.

FIG. 7D illustrates a system for implementing an API, in accordance with some embodiments.

FIGS. 7E and 7F illustrate data flows related to API processes, in accordance with some embodiments.

### DETAILED DESCRIPTION

In the following description, various embodiments will be described. For purposes of explanation, specific configurations and details are set forth in order to provide a thorough understanding of the embodiments. However, it will also be apparent to one of ordinary skill in the art that the embodiments may be practiced without the specific details. Furthermore, well-known features may be omitted or simplified in order not to obscure the embodiment being described.

Examples of the present disclosure are directed to, among other things, methods, systems, devices, and computer-readable media (collectively, “techniques”) for more efficiently and accurately executing actions using an artificial intelligence engine. In particular, a user may provide an input to a computing system (e.g., a smart home device, cell phone, tablet, or the like) that can control multiple accessory devices (e.g., a light, music player, scent diffuser, water sprinkler, or the like). A large language engine can process this input as a request to perform certain actions associated with one or more of the accessory devices, such as turning on or off, or changing a different operational state, certain of the accessory devices. An estimation engine can determine a certainty value of each action corresponding to the likelihood that the action is correctly associated with the received input. Actions above a certain threshold certainty value are presented to the user for selection. The user may select the desired action and the computing system may instruct the corresponding accessory device to perform the action.

The systems, devices, and techniques described herein provide several technical advantages that increase the efficiency and accuracy of artificial intelligence engines. Using artificial intelligence engines may result in hallucinations, where the artificial intelligence engine provides an output that is not correctly associated with a received user input. To address this issue, an artificial intelligence engine can provide multiple outputs associated with a received input and a certainty of each output (e.g., the likelihood that an output predicted by the artificial intelligence engine correctly corresponds to an input provided to the artificial intelligence engine) can be determined. Certainty determination methods are generally divided into two methodologies: white-box methods and black-box methods. However, each method has their own downsides.

For example, in white-box methods, the particular values relating that certainty to the input and output (e.g., the token logits, internal layer outputs, or the like) must be known in advance and used as a part of training the artificial intelligence engine in order for the artificial intelligence engine to estimate certainty. However, these values may not be readily accessible. In contrast, black-box methods can determine certainty by looking only at the output of the artificial intelligence engines. However, this method requires that the artificial intelligence engine be executed multiple times to provide multiple outputs before each output is individually analyzed for certainty, which can be computationally costly.

The present disclosure provides a more efficient method of determining certainty using artificial intelligence engines with either method. Rather than being executed multiple times to provide multiple outputs, the computing system of the present disclosure includes a large language engine that is trained to provide multiple outputs based on a single execution, resulting in a more computationally efficient manner of generating outputs. Additionally, the artificial intelligence engines of the present disclosure do not require the tokens and logits to estimate certainty. The computing system can also include an estimation engine that works in conjunction with the large language engine to generate certainty values for each output provided by the large language engine. As such, the computing system can provide multiple outputs that can each have an associated certainty value. These certainty values can be used to select the most appropriate output for the received input (e.g., providing only outputs that include a certainty level that are sufficiently above a certain threshold value or the like). In this manner, the computing system of the present disclosure can provide outputs that more accurately correspond to the received input, thereby decreasing the risk of hallucinations, in a more computationally cost-effective manner.

In one example use scenario, the computing system of the present disclosure may include a smart home device that stores a large language engine and estimation engine. The smart home device may be in communication with accessory devices that are capable of being instructed by the smart home device to perform actions. A user may provide a user input to the smart home device. The smart home device may execute the large language engine to generate multiple actions associated with the received user input. However, as the large language engine may not be sure which of those actions is the action the user actually desires, the computing system may execute an estimation engine to generate certainty values of each of the actions generated by the large language engine. The certainty value of each action can correspond to a likelihood that the generated action correctly corresponds to the user input. The certainty values of each action can then be compared to a certainty threshold value generated by the estimation engine. The actions with certainty values greater than the certainty threshold value can represent actions that have a likelihood of being correctly associated with a user input that is greater than a threshold likelihood represented by the certainty threshold value. The computing system can present to the user, for selection, the actions whose certainty values are greater than the certainty threshold value. The user can provide a second user input selecting an action and the computing system can then instruct the corresponding accessory device to perform the selected action.

In another example use scenario, a user may provide a user input to a computing system indicating that the user would like an action performed by an accessory device. The computing system can present to the user some options of actions that can be performed by one or more accessory devices. The user can select one of the options. The computing system can instruct the corresponding accessory device to perform the selected action.

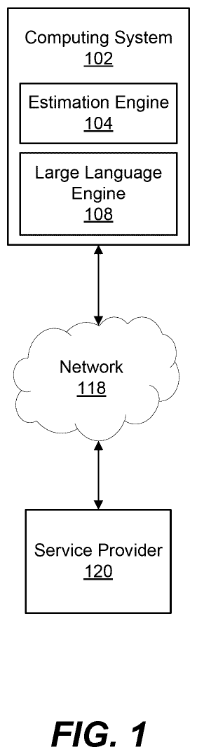

Turning now to the figures, FIG. 1 depicts a block diagram showing an example device environment 100, according to at least one example. The processes, and any other processes described herein, include operations that each can represent a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The device environment 100 may include a computing system 102, such as a smart home device, cellular phone, a tablet computing device, a laptop computer, a watch-based computing device, or the like. The computing system 102 may include input devices that can receive user inputs (e.g., a microphone, keyboards, mice, touchscreens, cameras, or the like) and output devices that can provide outputs (e.g., a speaker, a display, or the like). In one example, the computing system 102 may be a smart home device that can receive speech inputs from a user and may output audible outputs. The computing system 102 may control an accessory device to perform actions based on the user input, such as changing an operational state (e.g., turning on/off or the like) of a light, a speaker, a scent diffuser, water sprinkler, or other devices that are in communication with the computing system 102.

The computing system 102 may include memory that can store, and one or more processors that can execute, artificial intelligence engines, such as a large language engine 108 and an estimation engine 104. Artificial intelligence engines can be the software framework that stores and executes artificial intelligence models (e.g., large language models, estimation models, or the like). For example, the artificial intelligence engines can include modules that processes input data for the artificial intelligence models, modules that execute the artificial intelligence models, and modules that communicate output data from the artificial intelligence model. The artificial intelligence engines can also include modules that facilitates communication between the artificial intelligence models and other components in the computing system 102, such as other artificial intelligence engines, other artificial intelligence engines, or other programs stored by the computing system 102. Executing the artificial intelligence engines can also execute the artificial intelligence models stored in the artificial intelligence engine. In some embodiments, the computing system 102 may include additional artificial intelligence engines not depicted in FIG. 1.

The computing system 102 can communicate with a service provider 120 through a network 118 (e.g., the Internet, a wireless local area network, an Ethernet network, an intranet, an optical network, or other public or private network connection). The service provider 120 may include a computing device such as a server, a portion of a distributed computing device, or the like. In some embodiments, the service provider 120 can train the artificial intelligence models used in the artificial intelligence engines stored by the computing system 102 before transmitting those artificial intelligence models to the computing system 102. However, in other embodiments, the computing system may train the artificial intelligence models rather than the service provider.

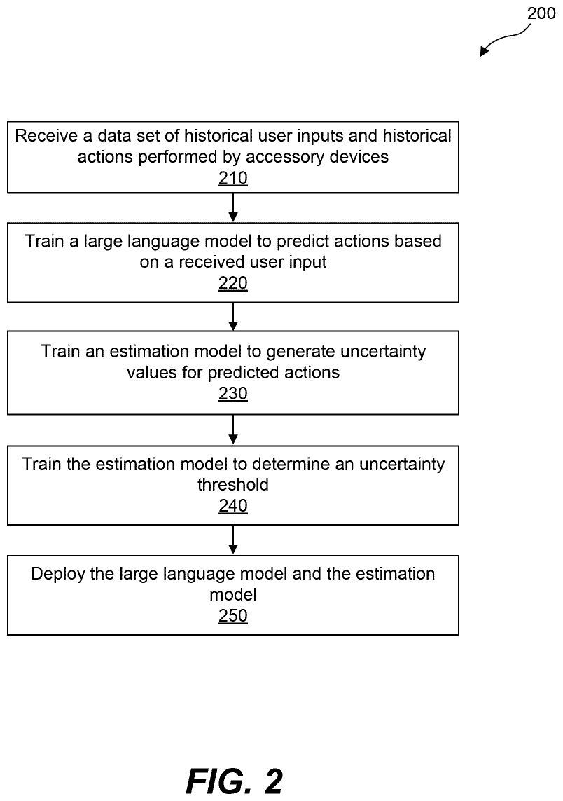

FIG. 2 is a flowchart depicting a process 200 for training artificial intelligence models. Unless noted otherwise, the process 200 will be performed by the electronic devices noted in the device environment 100. Although the process 200 will be described as being performed by service provider 120, it is understood that the process 200 can also be performed by the computing system 102, as noted above.

At block 210, the service provider 120 can receive a data set of historical user inputs and historical actions performed by accessory devices for each historical user input. For example, the data set may include data of historical user inputs provided to a computing system (e.g., the computing system 102, such as a smart home, or the like) and the historical actions performed by accessory devices (e.g., lights, music players, scent diffusers, sprinklers, or other home devices) for each of the historical user inputs. The data set may include a large amount of data points, such as greater than 15,000 data points, greater than 20,000 data points, greater than 25,000 data points, or the like.

Each historical input can be associated with historical actions to be performed by multiple accessory devices. As one example data point, a historical user input may include a user providing to the computing system (e.g., through a speech input, text input, or the like): “trimming the lawn.” In response, the historical actions may include turning on an outdoor light and playing nature music from a music player. In another example data point, a historical user input may include a user providing to the computing system: “unwinding after work.” In response, the historical actions may include turning on the bedroom light, playing soft music from the bedroom music player, and turning on the scent diffuser.

In some embodiments, rather than indirect requests for accessory devices to perform actions, the data set may include historical user inputs directly requesting for at least one accessory device to perform an action. For example, a historical input may include: “water the plants.” In response, the historical actions may include turning on the outdoor lights, playing laid-back music from the outdoor speaker, and turning on the sprinkler. In this manner, the data set may include historical user inputs that are both direct and indirect requests for accessory devices to perform actions.

At block 220, the service provider 120 may train a large language model to predict one or more actions available to be performed by accessory devices with the data set. In particular, the service provider 120 may use various machine learning techniques (e.g., supervised learning, unsupervised learning, deep learning, reinforced learning, or the like) to identify patterns between the historical user input and the historical actions. This can include training the large language model to identify patterns between multiple actions for each historical input. In this manner, the large language model can be trained to predict actions to be performed by accessory devices based on a received user input.

At block 230, the service provider 120 can train an estimation model to predict certainty values for prediction actions. For example, the service provider 120 may use various machine learning techniques (e.g., supervised learning, unsupervised learning, deep learning, reinforced learning, or the like) on the data set of historical inputs and historical actions according to statistical methods. As one example, the estimation model may be trained according to point-wise dependency estimation processes for each output. However, in other embodiments, other statistical methods may be used.

One example of a point-wise dependency estimation process may include incorporating density ratio fitting into a point-wise dependency formulation, as shown below:

$$\frac{γ {r}_{θ}^{*} ( a , {x}^{′} ) + α}{1 - β {r}_{θ}^{*} ( a , {x}^{′} )}$$

In this formulation: x′ represents the user prompts; a represents an action; θ represents the neural network; and α, β, and γ are hyper-parameters used to control for portions of the equation. In one example, α can be set to 1.0, β can be set to 0.005, and γ can be set to 0.1. However, in other embodiments, these hyperparameters can be set to other values.

Further, r_{θ}* (α, x′) can be represented as follows:

$${r}_{θ}^{*} ( a , {x}^{′} ) = 〈 {f}_{a}^{l} ∘ {f}_{a}^{g} ∘ {f}^{llm} ( a ) , {f}_{x}^{l} ∘ {f}_{x}^{g} ∘ {f}^{llm} ( x ) 〉$$

In this formulation: fₐ^{l}/fₓ^{l} represents fully-connected layers attached from the last unit in fₐ^{g}/fₓ^{g}; f^{llm} represents a pre-trained large language model; g represents gated recurrent units; and fₐ^{g}/fₓ^{g} represents gated recurrent units applied over the sequence outputs from f^{llm}. The neural network θ exists in fₐ^{g}/fₓ^{g} and fₐ^{l}/fₓ^{l}.

In some examples, according to the above formulations, the estimation model may be trained to identify certainty values such that values approaching 1 means that the output and the input are more unrelated and that positive values moving away from 1 means that the output and the input are more related. However, in other embodiments, the estimation model may be trained to identify other values that correspond with how related or unrelated the output and input are.

Although the present disclosure uses “certainty values” as corresponding to the values generated by the estimation model as representing the likelihood that a certain predicted action correctly corresponds to a user input as, the higher the certainty value, the more likely the predicted action correctly corresponds to the received user input. However, it should be understood that this value can also be referred to by its inverse: an “uncertainty value.” In particular, although the uncertainty value and the certainty value may be referring to the same numerical values of each predicted action, referring to an action's uncertainty value may refer to how far a predicted action is from correctly corresponding to the received user input. In this manner, the higher the uncertainty value, the farther that a predicted action is from correctly corresponding to the received user input.

At block 240, the service provider 120 can train the estimation model to determine a certainty threshold value corresponding to a certainty value at which a predicted action is unlikely to correctly correspond to a user input. For example, the service provider 120 may train the estimation model to only output the predicted actions with certainty levels that are higher than the certainty threshold value such that the predicted actions with a certainty level greater than the certainty threshold value represents a high likelihood (e.g., greater than about 80% likelihood, greater than about 90%, or completely certain) of correctly corresponding to the user input. The service provider 120 may train the estimation model using predictive measurement techniques. For example, the service provider 120 may train the estimation model to determine certainty threshold values according to conformal prediction processes. However, in other embodiments, other predictive measurement techniques can be used.

One example conformal prediction formulation used to train the estimation model may include:

$$P ( {a}_{true} ∈ C ( {x}_{test}^{′} ) ) \geq 1 - ϵ$$

In this formulation: x′ₜₑₛₜ represents a user prompt along with a historical action in response to the user prompt; αₜᵣᵤₑ represents a correct action to be executed given x′ₜₑₛₜ; (e.g., a “true” action); C(x′ₜₑₛₜ) represents a prediction set with a high probability of containing αₜᵣᵤₑ; and ϵ represents a likelihood that a predicted action is incorrect. As such, in one example, where ϵ is 20%, the certainty threshold value representing the probability that, given x′ₜₑₛₜ, a true action is among the generated actions is 1.627.

In some embodiments, the service provider 120 can train the estimation model to dynamically determine a certainty threshold value for each received user input. For example, the estimation model may provide higher certainty threshold values for user inputs with predicted actions that the estimation model can more confidently predict as being correctly associated with the user input. In this example, more actions can be filtered to leave only the actions that the estimation model is confident are correctly associated with the user input for presentation to the user. In contrast, the estimation model may provide lower certainty threshold values for user inputs with predicted actions that the estimation model is less confident is correctly associated with the user input, therefore filtering less actions and leaving more actions for presentation to the user.

In some examples, this dynamic change in certainty threshold value may be a result of the absolute difference in certainty values for the predicted actions between one user input and another user input. For example, a first user input may include three actions: a first action includes a first certainty value of 4.6, a second action includes a second certainty value of 4.0, and a third action includes a third certainty value of 1.3. In this example, the estimation model, as noted by the higher certainty values of the first and second actions compared to the third action, the estimation model may be confident that the first and second actions more correctly correspond to the received user input but is not sure which of those two actions are truly correct. However, the estimation model is confident that the third action does not correspond to the received user input. As such, the estimation model may generate a certainty threshold value for this particular user input as 3.6 such that the action that the estimation model is confident does not correctly correspond to the user input (e.g., the third action) is filtered out. In contrast, if all the predicted actions have a similar certainty value (e.g., within about a 20% deviation of each other, such as about a 10% deviation, such as about a 5% deviation, or being completely the same), the estimation model may not generate a certainty threshold value that would necessarily filter any of the actions out.

Although this example includes two actions as having particularly high certainty values relative to the third action, in other embodiments, there may be any number of actions that have a particularly high certainty value (e.g., one, four, five, six, or the like) compared to any number of actions that have a relatively low certainty value (e.g., two, three, four, or the like). In yet other embodiments, the estimation model may generate a certainty threshold value based on the average and/or median of the certainty values of the predicted outputs.

In other examples, the estimation model may be trained to generate a single certainty threshold value corresponding to the data set on which the estimation model is trained. As such, the estimation model may determine a pre-determined certainty threshold value that all certainty values of the predicted actions are compared against. In yet other embodiments, the estimation model may not be trained to determine a certainty threshold value and, instead, may output the predicted actions with certainty values without considering a threshold certainty value.

At block 250, the service provider 120 can deploy the large language model and the estimation model. For example, the service provider 120 may incorporate the large language model into the large language engine 108 and may incorporate the estimation model into the estimation engine 104. The service provider 120 may then transmit the large language engine 108 and the estimation engine 104 to the computing system 102 (e.g., via the network 118). However, in other embodiments, the service provider may transmit the large language model and the estimation model to the computing system without incorporating the models into the corresponding engines.

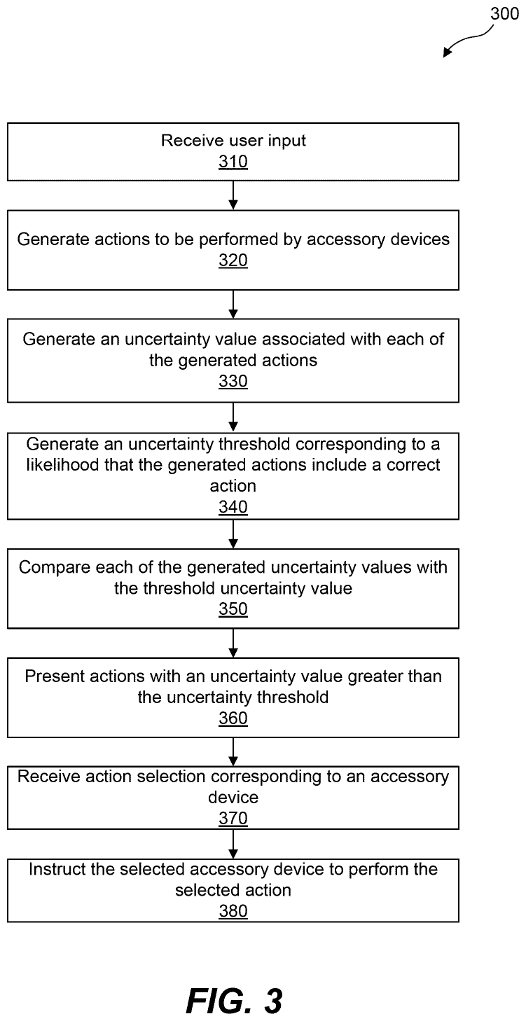

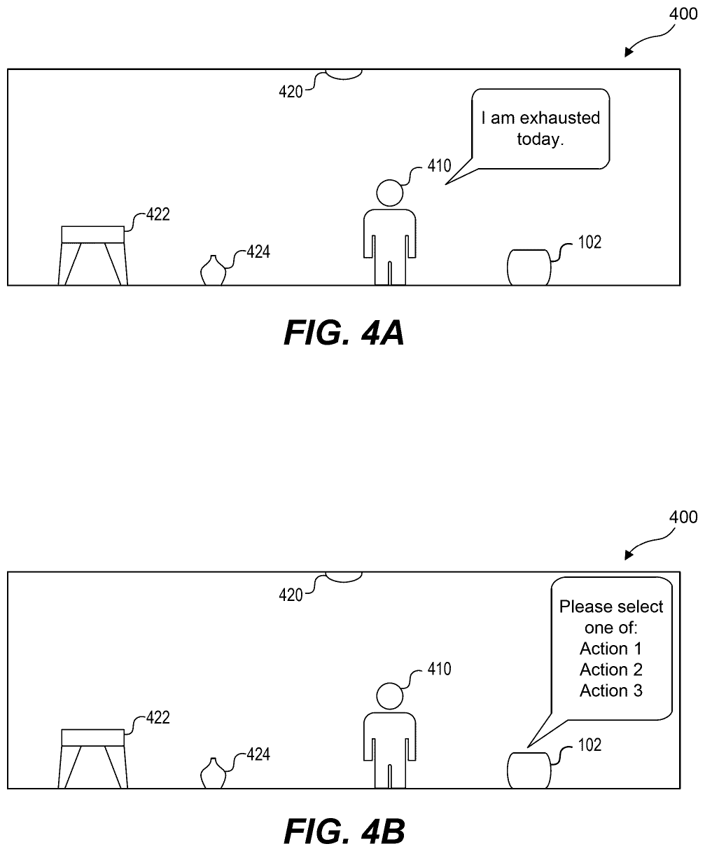

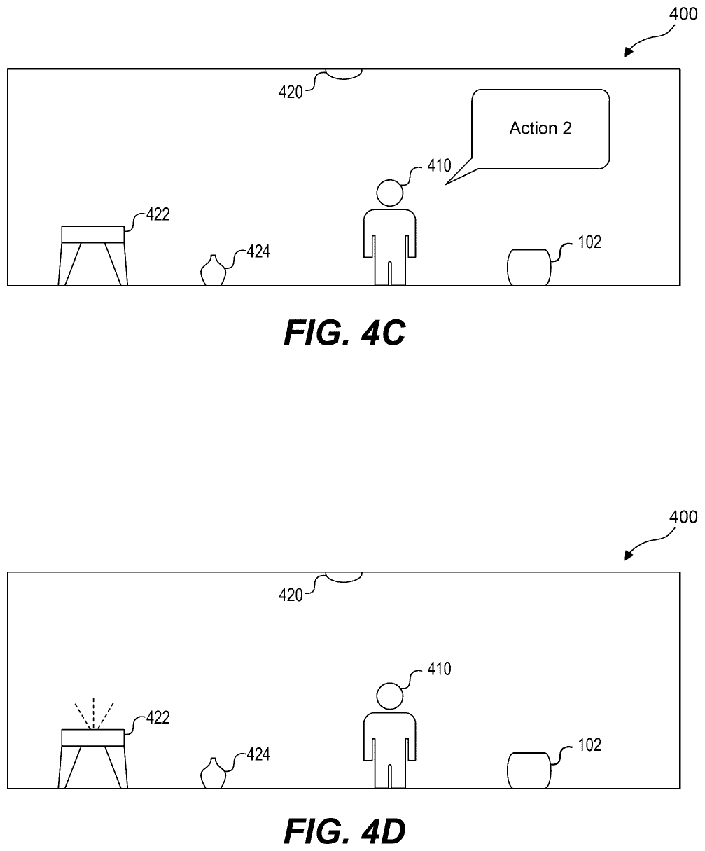

FIG. 3 is a flowchart depicting a process 300 for using the large language engine 108 and the estimation engine 104. The process 300 will be described with reference to an example use case of a home environment 400 shown in FIGS. 4A-4D. Unless noted otherwise, the process 300 will be performed by the electronic devices noted in the computing environment 100, such as the computing system 102.

At block 310, the computing system 102 can receive a user input. For example, with reference to FIG. 4A, the computing system 102 positioned in the home environment 400 may receive, from a user 410, a speech input of “I am exhausted today.”

At block 320, the computing system 102 can generate actions to be performed by accessory devices. The computing system 102 can execute the large language engine 108 to generate multiple actions capable of being performed by a first accessory device 420 (e.g., a light or the like), a second accessory device 422 (e.g., a music player or the like), and a third accessory device 424 (e.g., a scent diffuser or the like). For example, the computing system 102 may determine that, based on the speech input of the user 410, the user 410 wants the first accessory device 420 turned on to a dim light setting as a first action, the second accessory device 422 to play soft sounds as a second action, and/or the third accessory device 424 to emit a stored scent as a third action. The actions generated by the large language engine 108 can be actions predicted by the large language model of the large language engine 108. In other embodiments, the computing system may generate more or less than three actions, such as two actions, four actions, five actions, or the like.

At block 330, the computing system 102 can generate a certainty value for associated with each of the generated actions. For example, the computing system 102 may execute the estimation engine 104 to generate certainty values for each of the generated actions. The estimation engine 104 may generate a first certainty value for a first action corresponding to the first accessory device 420 as 2.206, a second certainty value for the action corresponding to the second accessory device 422 as 1.837, and a third certainty value for the action corresponding to the third accessory device 424 as 1.9281. The certainty values generated by the estimation engine 104 can be certainty values predicted by the estimation model of the estimation engine 104.

At block 340, the computing system 102 can generate a certainty threshold value corresponding to a likelihood that the generated actions include a correct action. For example, the computing system 102 can execute the estimation engine to generate a certainty threshold value of 1.562. This certainty threshold value may be specific to the user input provided by the user 410 or may be a pre-determined certainty threshold value that is generated based on the data set the estimation model of the estimation engine 104 was trained with.

At block 350, the computing system 102 can compare each of the generated certainty values with the threshold certainty value. For example, the computing system 102 can execute the estimation engine 104 to compare the certainty value of each generated action of the accessory devices 420, 422, 424 with the certainty threshold value. The actions that pass this threshold can be considered actions that have at least a minimum desired likelihood of being correctly associated with the received user input (e.g., at least 80% chance of being correct) while the actions that do not pass this threshold can be considered actions that do not such a high likelihood of being correctly associated with the received user input (e.g., actions with a less than 80% chance of being correct). In this example, all of the first action, second action, and third action have certainty values greater than the certainty threshold value. In other embodiments, the computing system can compare the certainty values with the certainty threshold value without executing the engine.

In other embodiments, where the certainty values of the predicted actions are all less than the certainty threshold value, the computing system may inform the user that the computing system is not sure what to do given the user's input. In this example, the computing system can present the generated actions by the large language engine that did not meet the certainty threshold value or may ask the user to re-phrase their input. In this manner, the computing system may provide a more honest and accurate response in comparison to conventional artificial models that confidently provides a response even when the response might not be correct (e.g., a hallucination). In another embodiment, if the certainty values of the predicted actions are less than the certainty threshold value only by a small margin (e.g., by less than about a 10% deviation of the certainty threshold value, such as less than about 5% deviation, such as less than about 3% deviation, or being completely the same), the computing system can present the actions with a caveat that the computing system is not completely certain if these actions are the actions that the user desired.

While the actions that pass the certainty threshold value have a high likelihood of being correctly associated with the received user input, as predicted by the estimation engine 104, neither the estimation engine 104 nor large language engine 108 can determine which action is clearly associated with the user input. As such, in order to best provide the correct action based on the user input, the computing system 102 may present the action and request that the user 410 select an action.

At block 360, the computing system 102 can present actions with a certainty value greater than the threshold certainty value. For example, with reference to FIG. 4B, the computing system 102 can present the first action (e.g., “Action 1, turn on the light to dim light setting”), the second action (e.g., “Action 2, play soft sounds from the music player”), and the third action (e.g., “Action 3, turn on the scent diffuser”) to the user (e.g., as an audible output) with a request to select one of the actions. In some embodiments, the computing system 102 can present the actions with the certainty values generated by the estimation engine 104. This may be beneficial for users that would like more data regarding how confident the estimation engine 104 believed each of the actions to be. However, in other embodiments, the actions may be presented without their certainty value. The computing system 102 can present the actions in order from the highest certainty value, first, to the lowers certainty value, last.

Although the computing system 102 presented all the actions that the large language engine 108 previously generated in response to the user input, in other embodiments, the computing system 102 may present less than all the generated actions (e.g., a subset of the generated actions), such as where less than all the generated actions have certainty values greater than the certainty threshold value. In other embodiments, the computing system can present the actions in any order, including from the lowest certainty value to the highest certainty value. In a yet further embodiment, the computing system can present the actions at random.

At block 370, the computing system 102 can receive an action selection from the user. For example, with reference to FIG. 4C, the computing system 102 can receive a user selection (e.g., another speech input) selecting Action 2, confirming that the second action of playing the soft sounds from the second accessory device 422 was the correct predicted action by the large language engine 108. This selection can be stored by the computing system 102 and labeled as being the correct action on receiving the user input of “I am exhausted today.” In some embodiments, the computing system 102 can provide this selection to the large language engine 108 and estimation engine 104 for further training such that both the models in the engines 104, 108 are refined to incorporate this additional data point. In other embodiments, the computing system 102 can transmit this selection to the service provider 120 for use in training other large language and estimation models to be later provided to the computing system 102 as an update to the engines 104, 108. In some embodiments, the computing system 102 can allow for the selection of only one action, however, in other embodiments, the user can select more than one action to be performed by the accessory devices at once.

At block 380, the computing system 102 can instruct the selected accessory device to perform the selected action. For example, with reference to FIG. 4D, the computing system 102 can instruct the second accessory device 422 to play soft sounds. In other embodiments, where the user selects multiple actions, the computing system can instruct each of the corresponding accessory devices to perform each of the selected actions at once.

In some embodiments, after the computing system 102 transmits the instructions to the selected accessory device, the computing system 102 may present the action(s) that were not selected to the user 410 and ask the user 410 whether the user 410 may also like to have those unselected action(s) performed. This may be beneficial where the computing system 102 only allows one action to be selected at a time and the user is interested in actions other than the selected action but did not get a chance to select. In the example depicted in FIGS. 4A-4D, the user 410 can select Action 1 after having selected Action 2 and the computing system 102 can instruct the first accessory device 420 to perform Action 1. The computing system 102 can repeat this process until there are no more actions to be presented (e.g., no more actions with certainty values greater than the certainty threshold value). In a yet further embodiment, after all the actions greater than the certainty threshold value are presented and selected/denied, the computing system can ask whether the user would like to hear the other actions the computing system generated but did not present (e.g., the actions with certainty values less than the certainty threshold value).

In some embodiments, the computing system 102 may present only one action at a time and ask the user 410 for confirmation regarding whether the presented action is correct. For example, the computing system 102 may present the action with the highest certainty value (e.g., the first action associated with the first accessory device 420) and ask for confirmation whether the first action is the desired action in response to the received user input. If the user 410 confirms that the first action is correct, the computing system 102 may instruct the first accessory device 420 to perform the first action. However, if the user 410 states that the first action is incorrect, the computing system 102 may present the action with the next highest certainty level (e.g., the second action) to the user and ask for confirmation whether the second action is the desired action in response to the received user input. The computing system 102 may continue with this process until the user 410 provides a confirmation that the presented action is the correct action.

Where the user 410 does not believe that any of the presented action(s) are correct, the user 410 can inform the computing system 102 accordingly in response to the presented action(s). In this example, the computing system 102 can present the action(s) that did not meet the certainty threshold value (e.g., either all at once, as shown in FIG. 4B, or one at a time). However, in other embodiments, the computing system can additionally or alternatively ask the user to re-phrase their initial input, inform the user that the computing system does not understand the input, or the computing system cannot perform the requested input.

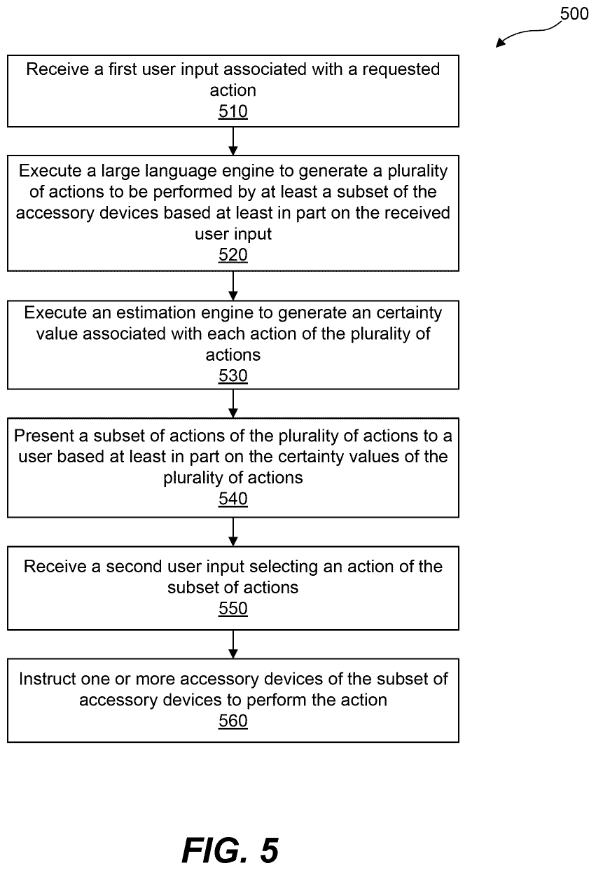

FIG. 5 depicts an example flowchart showing a process 500 for using the large language engine 108 and the estimation engine 104. Unless noted otherwise, the process 500 will be performed by the electronic devices noted in the computing environment 100.

At block 510, the computing system 102 can receive a first user input associated with a requested action. For example, with reference to FIG. 4A, the computing system 102 can receive a speech input from the user 410. However, in other embodiments, the computing system can receive other user inputs, such as a text input, interaction input (e.g., a click, tap, or swipe), or the like.

At block 520, the computing system 102 can execute a large language engine to generate a plurality of actions to be performed by at least a subset of the accessory devices based at least in part on the received user input. For example, the computing system 102 can execute the large language engine 108 to generate actions that can be performed by one or more of the accessory devices 420, 422, 424, such as a first action capable of being performed by the first accessory device 420, a second action capable of being performed by the second accessory device 422, and a third action capable of being performed by the third accessory device 424.

At block 530, the computing system 102 can execute an estimation engine to generate an uncertainty value associated with each action of the plurality of actions. For example, the computing system 102 can execute the estimation engine 104 to generate certainty values for each of the first action, second action, and third action. In some embodiments, the computing system 102 can compare (e.g., through executing the estimation engine 104 or the like) the certainty values of each of the first action, second action, and third action with a certainty threshold value to determine whether any of those certainty values are greater than the certainty threshold value. Where none of those actions are greater than the certainty threshold value, the computing system 102 can ask the user 410 to re-phrase/clarify the input, inform the user that the computing system 102 is unsure how to respond to the input, or the like.

At block 540, the computing system 102 can present a subset of actions of the plurality of actions to a user based at least in part on the certainty values of the plurality of actions. For example, with reference to FIG. 4B, the computing system 102 can present the first action, second action, and third action to the user 410 (e.g., via an audible output). However, in other embodiments, the computing system can present the actions in other forms, such as on a display, as a tactile sensation, or the like. Where the first action, second action, and third action are compared to a certainty threshold value, the computing system may present only the actions that were greater than the certainty threshold value.

At block 550, the computing system 102 can receive a second user input selecting an action of the subset of actions. For example, with reference to FIG. 4C, the computing system 102 can receive another speech input from the user 410 selecting the second action of the previously-presented actions. In other embodiments, this second speech input can be another user inputs, such as a text input, interaction input (e.g., a click, tap, or swipe), or the like.

At block 560, the computing system 102 can instruct one or more accessory devices of the subset of accessory devices to perform the action. For example, with reference to FIG. 4D, the computing system 102 can instruct the second accessory device 422 to perform the selected action (e.g., to play soft sounds). In some embodiments, the computing system 102 may present one or more actions of the rest of the unselected actions for the user to select from.

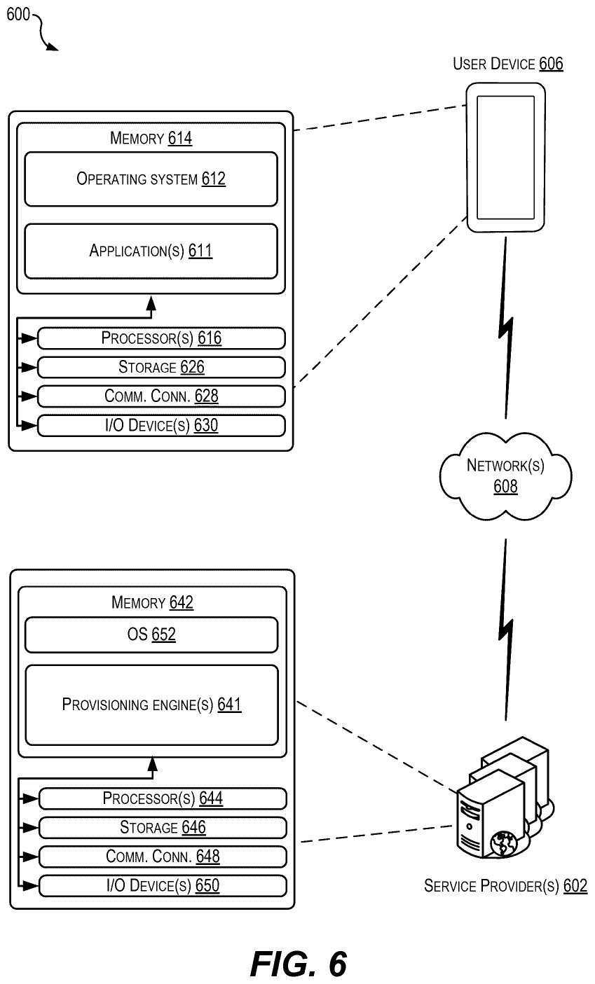

FIG. 6 illustrates an example architecture or environment 600 configured to implement

techniques described herein, according to at least one example. In some examples, the example architecture or environment 600 may further be configured to enable a user device 606 and service provider computer 602 to share information. The service provider computer 602 is an example of the service provider 120. The user device 606 is an example of the computing system 102. In some examples, the devices may be connected via one or more networks 608 (e.g., via Bluetooth, WiFi, the Internet, or the like). In some examples, the service provider computer 602 may be configured to implement at least some of the techniques described herein with reference to the user device 606.

In some examples, the networks 608 may include any one or a combination of many different types of networks, such as cable networks, the Internet, wireless networks, cellular networks, satellite networks, other private and/or public networks, or any combination thereof. While the illustrated example represents the user device 606 accessing the service provider computer 602 via the networks 608, the described techniques may equally apply in instances where the user device 606 interacts with the service provider computer 602 over a landline phone, via a kiosk, or in any other manner. It is also noted that the described techniques may apply in other client/server arrangements (e.g., set-top boxes, etc.), as well as in non-client/server arrangements (e.g., locally stored applications, peer-to-peer configurations, etc.).

As noted above, the user device 606 may be any type of computing device such as, but not limited to, a mobile phone, a smartphone, a personal digital assistant (PDA), a laptop computer, a desktop computer, a thin-client device, a tablet computer, a wearable device such as a smart watch, or the like. In some examples, the user device 606 may be in communication with the service provider computer 602 via the network 608, or via other network connections.

In one illustrative configuration, the user device 606 may include at least one memory 614 and one or more processing units (or processor(s)) 616. The processor(s) 616 may be implemented as appropriate in hardware, computer-executable instructions, firmware, or combinations thereof. Computer-executable instruction or firmware implementations of the processor(s) 616 may include computer-executable or machine-executable instructions written in any suitable programming language to perform the various functions described. The user device 606 may also include geo-location devices (e.g., a global positioning system (GPS) device or the like) for providing and/or recording geographic location information associated with the user device 606.

The memory 614 may store program instructions that are loadable and executable on the processor(s) 616, as well as data generated during the execution of these programs. Depending on the configuration and type of the user device 606, the memory 614 may be volatile (such as random-access memory (RAM)) and/or non-volatile (such as read-only memory (ROM), flash memory, etc.). The user device 606 may also include additional removable storage and/or non-removable storage 626 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 614 may include multiple different types of memory, such as static random-access memory (SRAM), dynamic random-access memory (DRAM), or ROM. While the volatile memory described herein may be referred to as RAM, any volatile memory that would not maintain data stored therein once unplugged from a host and/or power would be appropriate.

The memory 614 and the additional storage 626, both removable and non-removable, are all examples of non-transitory computer-readable storage media. For example, non-transitory computer readable storage media may include volatile or non-volatile, removable or non-removable media implemented in any method or technology for storage of information such as computer-readable instructions, data structures, program modules, or other data. The memory 614 and the additional storage 626 are both examples of non-transitory computer storage media.

Additional types of computer storage media that may be present in the user device 606 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 606. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 606 may also contain communications connection(s) 628 that allow the user device 606 to communicate with a data store, another computing device or server, user terminals, and/or other devices via the network 608. The user device 606 may also include I/O device(s) 630, such as a keyboard, a mouse, a pen, a voice input device, a touch screen input device, a display, speakers, a printer, etc.

Turning to the contents of the memory 614 in more detail, the memory 614 may include an operating system 612 and/or one or more application programs or services for implementing the features disclosed herein such as applications 611 (e.g., digital wallet, third-party applications, browser application, etc.). In some examples, the service provider computer 602 may also include a health application to perform similar techniques as described with reference to the user device 606. Similarly, at least some techniques described with reference to the service provider computer 602 may be performed by the user device 606.

The service provider computer 602 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, a virtual machine instance, etc. In some examples, the service provider computer 602 may be in communication with the user device 606 via the network 608, or via other network connections.

In one illustrative configuration, the service provider computer 602 may include at least one memory 642 and one or more processing units (or processor(s)) 644. The processor(s) 644 may be implemented as appropriate in hardware, computer-executable instructions, firmware, or combinations thereof. Computer-executable instruction or firmware implementations of the processor(s) 644 may include computer-executable or machine-executable instructions written in any suitable programming language to perform the various functions described.

The memory 642 may store program instructions that are loadable and executable on the processor(s) 644, as well as data generated during the execution of these programs.

Depending on the configuration and type of service provider computer 602, the memory 642 may be volatile (such as RAM) and/or non-volatile (such as ROM, flash memory, etc.). The service provider computer 602 may also include additional removable storage and/or non-removable storage 646 including, but not limited to, magnetic storage, optical disks, and/or tape storage. The disk drives and their associated non-transitory computer-readable media may provide non-volatile storage of computer-readable instructions, data structures, program modules, and other data for the computing devices. In some implementations, the memory 642 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 642 and the additional storage 646, both removable and non-removable, are both additional examples of non-transitory computer-readable storage media.

The service provider computer 602 may also contain communications connection(s) 648 that allow the service provider computer 602 to communicate with a data store, another computing device or server, user terminals and/or other devices via the network 608. The service provider computer 602 may also include I/O device(s) 650, such as a keyboard, a mouse, a pen, a voice input device, a touch input device, a display, speakers, a printer, etc.

Turning to the contents of the memory 642 in more detail, the memory 642 may include an operating system 652 and/or one or more application programs or services for implementing the features disclosed herein including a provisioning engine(s) 641.

Implementations within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, widgets, processes, software, and/or components.

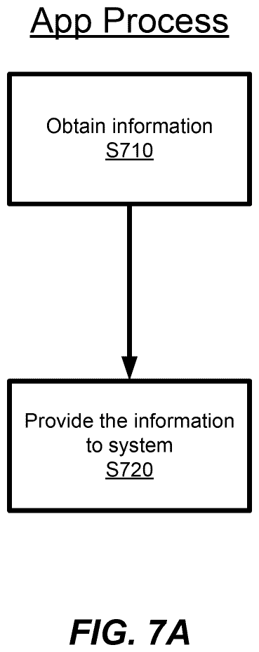

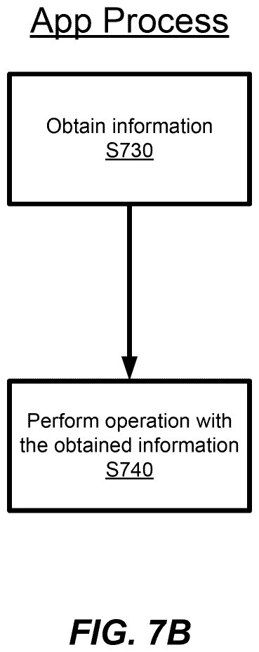

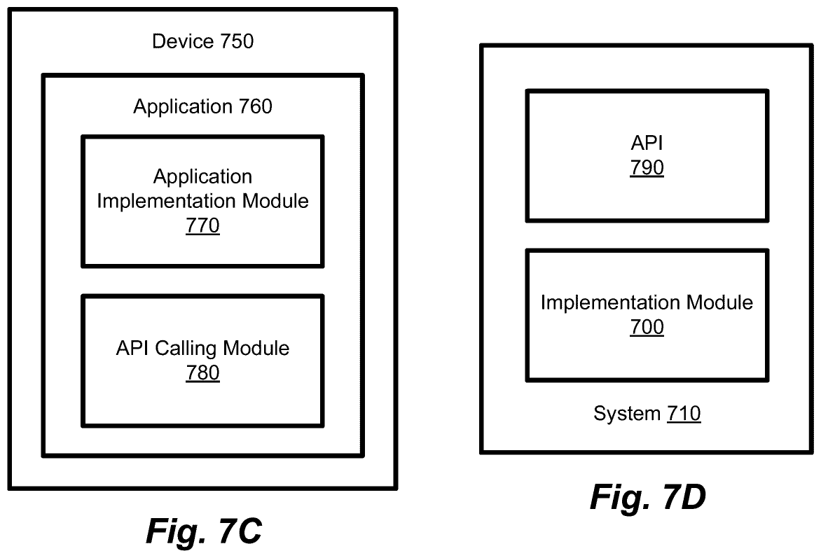

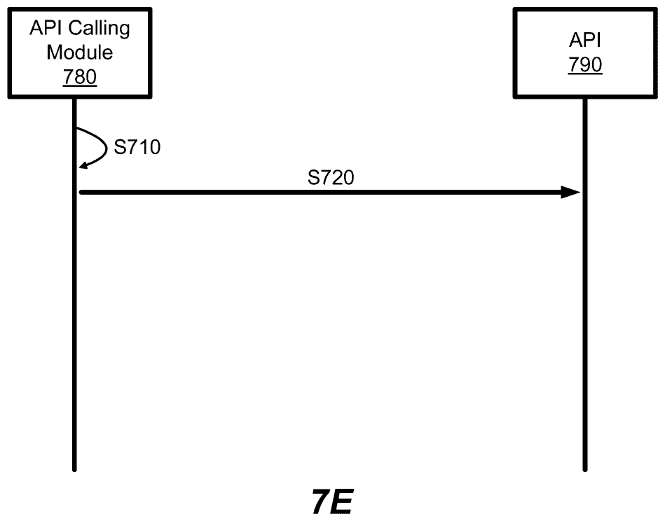

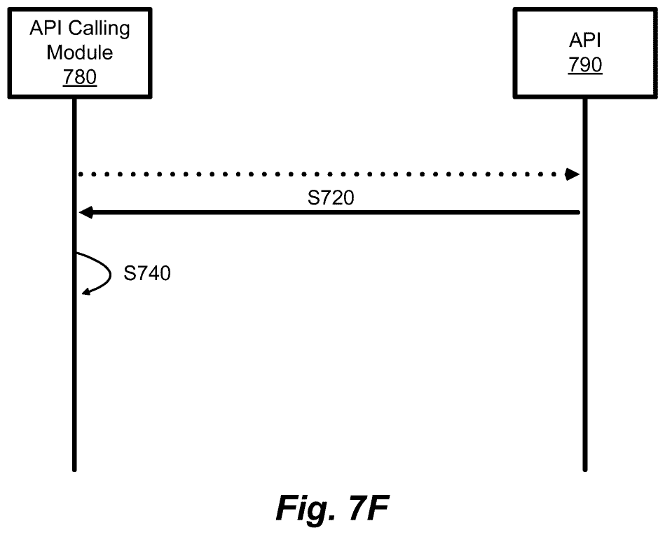

Implementations within the scope of the present disclosure include a computer-readable storage medium that encodes instructions organized as an application (e.g., application 760) that, when executed by one or more processing units, control an electronic device (e.g., device 750) to perform the method of FIG. 7B, the method of FIG. 7C, and/or one or more other processes and/or methods described herein.

It should be recognized that application 760 (shown in FG. 7D) can be any suitable type of application, including, for example, one or more of: an accessory companion application, a browser application, an application that functions as an execution environment for plug-ins, widgets or other applications, a fitness application, a health application, a digital payments application, a media application, a social network application, a messaging application, and/or a maps application. In some embodiments, application 760 is an application that is pre-installed on device 750 at purchase (e.g., a first party application). In other embodiments, application 760 is an application that is provided to device 750 via an operating system update file (e.g., a first party application or a second party application). In other embodiments, application 760 is an application that is provided via an application store. In some embodiments, the application store can be an application store that is pre-installed on device 750 at purchase (e.g., a first party application store). In other embodiments, the application store is a third-party application store (e.g., an application store that is provided by another application store, downloaded via a network, and/or read from a storage device).

Referring to FIG. 7B and FIG. 7F, application 760 obtains information (e.g., S710). In some embodiments, at S710, information is obtained from at least one hardware component of the device 750. In some embodiments, at S710, information is obtained from at least one software module of the device 750. In some embodiments, at S710, information is obtained from at least one hardware component external to the device 750 (e.g., a peripheral device, an accessory device, a server, etc.). In some embodiments, the information obtained at S710 includes positional information, time information, notification information, user information, environment information, electronic device state information, weather information, media information, historical information, event information, hardware information, and/or motion information. In some embodiments, in response to and/or after obtaining the information at S710, application 760 provides the information to a system (e.g., S720).

In some embodiments, the system (e.g., 710 shown in FIG. 7E) is an operating system hosted on the device 750. In some embodiments, the system (e.g., 710 shown in FIG. 7E) is an external device (e.g., a server, a peripheral device, an accessory, a personal computing device, etc.) that includes an operating system.

Referring to FIG. 7C and FIG. 7G, application 760 obtains information (e.g., S730). In some embodiments, the information obtained at S730 includes positional information, time information, notification information, user information, environment information electronic device state information, weather information, media information, historical information, event information, hardware information and/or motion information. In response to and/or after obtaining the information at S730, application 760 performs an operation with the information (e.g., S740). In some embodiments, the operation performed at S740 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 710 based on the information.

In some embodiments, one or more steps of the method of FIG. 7B and/or the method of FIG. 7C is performed in response to a trigger. In some embodiments, the trigger includes detection of an event, a notification received from system 710, a user input, and/or a response to a call to an API provided by system 710.

In some embodiments, the instructions of application 760, when executed, control device 750 to perform the method of FIG. 7B and/or the method of FIG. 7C by calling an application programming interface (API) (e.g., API 790) provided by system 710. In some embodiments, application 760 performs at least a portion of the method of FIG. 7B and/or the method of FIG. 7C without calling API 790.

In some embodiments, one or more steps of the method of FIG. 7B and/or the method of FIG. 7C includes calling an API (e.g., API 790) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 7D, device 750 is illustrated. In some embodiments, device 750 is a personal computing device, a smart phone, a smart watch, a fitness tracker, a head mounted display (HMD) device, a media device, a communal device, a speaker, a television, and/or a tablet. As illustrated in FIG. 7D, device 750 includes application 760 and operating system (e.g., system 710 shown in FIG. 7E). Application 760 includes application implementation module 770 and API calling module 780. System 710 includes API 790 and implementation module 700. It should be recognized that device 750, application 760, and/or system 710 can include more, fewer, and/or different components than illustrated in FIG. 7D and 7E.

In some embodiments, application implementation module 770 includes a set of one or more instructions corresponding to one or more operations performed by application 760. For example, when application 760 is a messaging application, application implementation module 770 can include operations to receive and send messages. In some embodiments, application implementation module 770 communicates with API calling module to communicate with system 710 via API 790 (shown in FIG. 7E).

In some embodiments, API 790 is a software module (e.g., a collection of computer-readable instructions) that provides an interface that allows a different module (e.g., API calling module 780) to access and/or use one or more functions, methods, procedures, data structures, classes, and/or other services provided by implementation module 700 of system 710. For example, API-calling module 780 can access a feature of implementation module 700 through one or more API calls or invocations (e.g., embodied by a function or a method call) exposed by API 790 and can pass data and/or control information using one or more parameters via the API calls or invocations. In some embodiments, API 790 allows application 760 to use a service provided by a Software Development Kit (SDK) library. In other embodiments, application 760 incorporates a call to a function or method provided by the SDK library and provided by API 790 or uses data types or objects defined in the SDK library and provided by API 790. In some embodiments, API-calling module 780 makes an API call via API 790 to access and use a feature of implementation module 700 that is specified by API 790. In such embodiments, implementation module 700 can return a value via API 790 to API-calling module 780 in response to the API call. The value can report to application 760 the capabilities or state of a hardware component of device 750, including those related to aspects such as input capabilities and state, output capabilities and state, processing capability, power state, storage capacity and state, and/or communications capability. In some embodiments, API 790 is implemented in part by firmware, microcode, or other low-level logic that executes in part on the hardware component.

In some embodiments, API 790 allows a developer of API-calling module 780 (which can be a third-party developer) to leverage a feature provided by implementation module 700. In such embodiments, there can be one or more API-calling modules (e.g., including API-calling module 780) that communicate with implementation module 700. In some embodiments, API 790 allows multiple API-calling modules written in different programming languages to communicate with implementation module 700 (e.g., API 790 can include features for translating calls and returns between implementation module 700 and API-calling module 780) while API 790 is implemented in terms of a specific programming language. In some embodiments, API-calling module 780 calls APIs from different providers such as a set of APIs from an OS provider, another set of APIs from a plug-in provider, and/or another set of APIs from another provider (e.g., the provider of a software library) or creator of the another set of APIs.

Examples of API 790 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API. In some embodiments the sensor API is an API for accessing data associated with a sensor of device 750. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 700 is a system (e.g., operating system, server system) software module (e.g., a collection of computer-readable instructions) that is constructed to perform an operation in response to receiving an API call via API 790. In some embodiments, implementation module 700 is constructed to provide an API response (via API 790) as a result of processing an API call. By way of example, implementation module 700 and API-calling module 180 can each be any one of an operating system, a library, a device driver, an API, an application program, or other module. It should be understood that implementation module 700 and API-calling module 780 can be the same or different type of module from each other. In some embodiments, implementation module 700 is embodied at least in part in firmware, microcode, or other hardware logic.

In some embodiments, implementation module 700 returns a value through API 790 in response to an API call from API-calling module 780. While API 790 defines the syntax and result of an API call (e.g., how to invoke the API call and what the API call does), API 790 might not reveal how implementation module 700 accomplishes the function specified by the API call. Various API calls are transferred via the one or more application programming interfaces between API-calling module 780 and implementation module 700. Transferring the API calls can include issuing, initiating, invoking, calling, receiving, returning, and/or responding to the function calls or messages. In other words, transferring can describe actions by either of API-calling module 780 or implementation module 700. In some embodiments, a function call or other invocation of API 790 sends and/or receives one or more parameters through a parameter list or other structure.

In some embodiments, implementation module 700 provides more than one API, each providing a different view of or with different aspects of functionality implemented by implementation module 700. For example, one API of implementation module 700 can provide a first set of functions and can be exposed to third party developers, and another API of implementation module 700 can be hidden (e.g., not exposed) and provide a subset of the first set of functions and also provide another set of functions, such as testing or debugging functions which are not in the first set of functions. In some embodiments, implementation module 700 calls one or more other components via an underlying API and thus be both an API calling module and an implementation module. It should be recognized that implementation module 700 can include additional functions, methods, classes, data structures, and/or other features that are not specified through API 790 and are not available to API calling module 780. It should also be recognized that API calling module 780 can be on the same system as implementation module 700 or can be located remotely and access implementation module 700 using API 790 over a network. In some embodiments, implementation module 700, API 790, and/or API-calling module 780 is stored in a machine-readable medium, which includes any mechanism for storing information in a form readable by a machine (e.g., a computer or other data processing system).

For example, a machine-readable medium can include magnetic disks, optical disks, random access memory; read only memory, and/or flash memory devices.

In some embodiments, process 700 (FIG. 7) is performed at a first computer system (as described herein) via a system process (e.g., an operating system process, a server system process) that is different from one or more applications executing and/or installed on the first computer system.

In some embodiments, process 200 (FIG. 2), process 300 (FIG. 3), and/or process 500 (FIG. 5) is performed at a first computer system (as described herein) by an application that is different from a system process. In some embodiments, the instructions of the application, when executed, control the first computer system to perform process 200 (FIG. 2), process 300 (FIG. 3), and/or process 500 (FIG. 5) by calling an application programming interface (API) provided by the system process. In some embodiments, the application performs at least a portion of process 200, process 300, and/or process 500 without calling the API.

In some embodiments, the application is an accessory companion application that is constructed for processing communication and management between the first computer system and an accessory device (e.g., a wearable device, such as, for example, a watch).

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform the method shown in FIG. 7 by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a bluetooth API, an NFC API, a UWB API, a fitness API, a smart home API, contact transfer API, photos API, camera API, and/or image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, the API 790 defines a first API call that can be provided by API calling module 790. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 750) that runs the application. In some embodiments, the implementation module is included in an electronic device that is separate from the device that runs the application.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text).

Generative content is typically generated by an AI process based on a prompt that is provided to the AI process. An AI process typically uses one or more Al models to generate an output based on an input. An AI process optionally includes one or more pre-processing steps to adjust the input before it is used by the AI model to generate an output (e.g., adjustment to a user-provided prompt, creation of a system-generated prompt, and/or Al model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

The various examples further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Most examples utilize at least one network that would be familiar to those skilled in the art for supporting communications using any of a variety of commercially available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In examples utilizing a network server, the network server can run any of a variety of server or mid-tier applications, including HTTP servers, FTP servers, CGI servers, data servers, Java servers, and business application servers. The server(s) may also be capable of executing programs or scripts in response to requests from user devices, such as by executing one or more applications that may be implemented as one or more scripts or programs written in any programming language, such as Java®, C, C #or C++, or any scripting language, such as Perl, Python or TCL, as well as combinations thereof. The server(s) may also include database servers, including without limitation those commercially available from Oracle®, Microsoft®, Sybase®, and IBM®.

The environment can include a variety of data stores and other memory, and storage media as discussed above. These can reside in a variety of locations, such as on a storage medium local to (and/or resident in) one or more of the computers or remote from any or all of the computers across the network. In a particular set of examples, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or browser. It should be appreciated that alternate examples may have numerous variations from that described above. For example, customized hardware might also be used and/or particular elements might be implemented in hardware, software (including portable software, such as applets) or both. Further, connection to other computing devices such as network input/output devices may be employed.

Non-transitory storage media and computer-readable media for containing code, or portions of code, can include any appropriate media known or used in the art, including storage media, such as, but not limited to, volatile and non-volatile, removable and non-removable media implemented in any method or technology for storage of information such as computer-readable instructions, data structures, program modules, or other data, including RAM, ROM, EEPROM, flash memory or other memory technology, CD-ROM, DVD or other optical storage, magnetic cassettes, magnetic tape, magnetic disk storage or other magnetic storage devices, or any other medium which can be used to store the desired information and which can be accessed by a system device. Based at least in part on the disclosure and teachings provided herein, a person of ordinary skill in the art will appreciate other ways and/or methods to implement the various examples.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated examples thereof are shown in the drawings and have been described above in detail.

It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (e.g., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate examples of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Preferred examples of this disclosure are described herein, including the best mode known to the inventors for carrying out the disclosure. Variations of those preferred examples may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

As described above, one aspect of the present technology is the gathering and use of data available from various sources to provide a comprehensive and complete window to a user's personal record. The present disclosure contemplates that in some instances, this gathered data may include personally identifiable information (PII) data that uniquely identifies or can be used to contact or locate a specific person. Such personal information data can include demographic data, location-based data, telephone numbers, email addresses, Twitter ID's, home addresses, data or records relating to a user's health or level of fitness (e.g., vital sign measurements, medication information, exercise information), date of birth, health record data, or any other identifying or personal or health information.

The present disclosure recognizes that the use of such personal information data, in the present technology, can be used to the benefit of users. For example, the personal information data can be used to provide enhancements to a user's personal health record. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the U.S., collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services or other services relating to health record management, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

What is claimed is:

1. A computer-implemented method comprising:
receiving, by a computing system configured to control accessory devices, a first user input associated with a requested action;
executing, by the computing system, a large language engine to generate a plurality of actions to be performed by at least a subset of the accessory devices based at least in part on the received user input;
executing, by the computing system, an estimation engine to generate a certainty value associated with each action of the plurality of actions;
presenting, by the computing system, a subset of actions of the plurality of actions to a user based at least in part on the certainty values of the plurality of actions;
receiving, by the computing system, a second user input selecting an action of the subset of actions; and
instructing, by the computing system, one or more accessory devices of the at least a subset of the accessory devices to perform the action.

2. The computer-implemented method of claim 1, wherein presenting the subset of actions includes presenting the subset of actions with the certainty value of each action.

3. The computer-implemented method of claim 1, further comprising:
generating a certainty threshold value corresponding to a likelihood that a correct action is among the plurality of actions;
comparing the certainty value of each action to the certainty threshold value; and
identifying actions of the plurality of actions with certainty values greater than the threshold certainty value as the subset of actions for presentation.

4. The computer-implemented method of claim 1, further comprising training a large language model to predict one or more actions available to be performed by the accessory devices based at least in part on a data set of historical user inputs and historical actions capable of being performed by the accessory devices for each historical input, wherein the large language engine includes the large language model such that executing the large language engine also executes the large language model.

5. The computer-implemented method of claim 4, wherein the data set includes between 15,000 and 25,000 data points.

6. The computer-implemented method of claim 4, further comprising training an estimation model to predict certainty values for future actions based at least in part on the data set, wherein:
the certainty values correspond to a likelihood that the future actions is correctly associated with future user inputs; and
the estimation engine includes the estimation model such that executing the estimation engine also executes the estimation model.

7. The computer-implemented method of claim 6, further comprising training the estimation model includes training the estimation model based at least in part on a point-wise dependency estimation process.

8. The computer-implemented method of claim 6, further comprising training the estimation model to predict a certainty threshold value that a correct action will be among the future actions for each user input based at least in part on the data set, wherein each action of the subset of actions includes a corresponding certainty value greater than the certainty threshold value.

9. The computer-implemented method of claim 8, wherein training the estimation model includes training the estimation model based at least in part on a conformal prediction process.

10. One or more non-transitory computer-readable media comprising computer-executable instructions that, when executed by one or more processors, cause the one or more processors to perform operations comprising:
receiving, by a computing system configured to control accessory devices, a first user input associated with a requested action;
executing, by the computing system, a large language engine to generate a plurality of actions to be performed by at least a subset of the accessory devices based at least in part on the received user input;
executing, by the computing system, an estimation engine to generate a certainty value associated with each action of the plurality of actions;
presenting, by the computing system, a subset of actions of the plurality of actions to a user based at least in part on the certainty values of the plurality of actions;
receiving, by the computing system, a second user input selecting an action of the subset of actions; and
instructing, by the computing system, one or more accessory devices of the at least a subset of the accessory devices to perform the action.

11. The one or more non-transitory computer-readable media of claim 10, wherein presenting the subset of actions includes presenting the subset of actions with the certainty value of each action.

12. The one or more non-transitory computer-readable media of claim 10, wherein the operations further comprise:
generating a certainty threshold value corresponding to a likelihood that a correct action is among the plurality of actions;
comparing the certainty value of each action to the certainty threshold value; and
identifying actions of the plurality of actions with certainty values greater than the threshold certainty value as the subset of actions for presentation.

13. The one or more non-transitory computer-readable media of claim 10, wherein the operations further comprise training a large language model to predict one or more actions available to be performed by the accessory devices based at least in part on a data set of historical user inputs and historical actions capable of being performed by the accessory devices for each historical input, wherein the large language engine includes the large language model such that executing the large language engine also executes the large language model.

14. The one or more non-transitory computer-readable media of claim 13, wherein the operations further comprise training an estimation model to predict certainty values for future actions based at least in part on the data set and a point-wise dependency estimation process, wherein:
the certainty values correspond to a likelihood that the future actions is correctly associated with future user inputs; and
the estimation engine includes the estimation model such that executing the estimation engine also executes the estimation model.

15. The one or more non-transitory computer-readable media of claim 14, wherein the operations further comprise training the estimation model to predict a certainty threshold value that a correct action will be among the future actions for each user input based at least in part on the data set and a conformal prediction process, wherein each action of the subset of actions includes a corresponding certainty value greater than the certainty threshold value.

16. A system comprising:
a memory comprising computer-executable instructions; and
a processor configured to access the memory and execute the computer-executable instructions to at least:
receive, by a computing system configured to control accessory devices, a first user input associated with a requested action;
execute, by the computing system, a large language engine to generate a plurality of actions to be performed by at least a subset of the accessory devices based at least in part on the received user input;
execute, by the computing system, an estimation engine to generate a certainty value associated with each action of the plurality of actions;
present, by the computing system, a subset of actions of the plurality of actions to a user based at least in part on the certainty values of the plurality of actions;
receive, by the computing system, a second user input selecting an action of the subset of actions; and
instruct, by the computing system, one or more accessory devices of the at least a subset of the accessory devices to perform the action.

17. The system of claim 16, wherein presenting the subset of actions includes presenting the subset of actions with the certainty value of each action.

18. The system of claim 16, wherein the computer-executable instructions further comprise:
generating a certainty threshold value corresponding to a likelihood that a correct action is among the plurality of actions;
comparing the certainty value of each action to the certainty threshold value; and
identifying actions of the plurality of actions with certainty values greater than the threshold certainty value as the subset of actions for presentation.

19. The system of claim 16, wherein the computer-executable instructions further comprise training a large language model to predict one or more actions available to be performed by the accessory devices based at least in part on a data set of historical user inputs and historical actions capable of being performed by the accessory devices for each historical input, wherein the large language engine includes the large language model such that executing the large language engine also executes the large language model.

20. The system of claim 19, wherein the computer-executable instructions:
training an estimation model to predict certainty values for future actions based at least in part on the data set and a point-wise dependency estimation process, wherein:
the certainty values correspond to a likelihood that the future actions is correctly associated with future user inputs; and
the estimation engine includes the estimation model such that executing the estimation engine also executes the estimation model; and
training the estimation model to predict a certainty threshold value that a correct action will be among the future actions for each user input based at least in part on the data set and a conformal prediction process, wherein each action of the subset of actions includes a corresponding certainty value greater than the certainty threshold value.
